(19) United States
(12) Patent Application Publication
(10) Pub. No.: US 2017/0242313 A1
(43) Pub. Date: Aug. 24, 2017

(54) Encapsulated Electrochromic Display, and Methods of Making and Using the Same

(71) Applicants: Annelie EVEBORN, Linkoping (SE); Olle HAGEL, Linkoping (SE); Jakob NILSSON, Linkoping (SE); Susanne NORLEN, Linkoping (SE); Mikko PAAKKOLANVAARA, Liminka (FI)

(72) Inventors: Annelie EVEBORN, Linkoping (SE); Olle HAGEL, Linkoping (SE); Jakob NILSSON, Linkoping (SE); Susanne NORLEN, Linkoping (SE); Mikko PAAKKOLANVAARA, Liminka (FI)

(73) Assignee: Thin Film Electronics ASA, Oslo (NO)

(21) Appl. No.: 15/439,472

(22) Filed: Feb. 22, 2017

Related U.S. Application Data
(60) Provisional application No. 62/298,949, filed on Feb. 23, 2016.

(51) Int. Cl. G02F 1/155; G02F 1/161

(52) U.S. Cl. CPC G02F 1/155; G02F 1/161; G02F 2202/28

(57) ABSTRACT

The present disclosure concerns an encapsulated electrochromic display and a method for encapsulating the same. The method includes forming the electrochromic display on a first encapsulation layer, conditioning the electrochromic display in an environment having a predetermined minimum water vapor therein, and applying a second encapsulation layer on the electrochromic display. The electrochromic display includes at least a first electrode, a second electrode, and an electrochromic layer between the first and second electrodes. At least one of the first and second electrodes is formed by a roll-to-roll printing process and comprises a material having an air or water vapor permeability sufficient to allow water vapor to permeate the electrochromic layer during the roll-to-roll printing process, and at least one of the first and second encapsulation layers is optically transparent. In the encapsulated electrochromic display, the electrochromic layer includes a predetermined minimum amount of water or moisture therein.

### CROSS REFERENCE TO RELATED APPLICATION

This application claims the benefit of U.S. Provisional Pat. Appl. No. 62/298,949, filed on Feb. 23, 2016, incorporated herein by reference as if fully set forth herein.

### FIELD OF THE INVENTION

The present invention generally relates to the field of electrochromic displays. More specifically, embodiments of the present invention pertain to an encapsulated electrochromic display, and a method for encapsulating and using an electrochromic display.

### DISCUSSION OF THE BACKGROUND

Electrochromic displays are widely known and used in various display applications since they have a low power consumption and the raw materials used in electrochromic displays are low cost materials.

U.S. Pat. No. 4,331,386 discloses an electrochromic display cell including front and rear glass substrates, a liquid electrolyte between the substrates, and a porous ceramic plate disposed in the liquid electrolyte.

Unfortunately, this electrochromic display has a drawback in that it is sensitive to humidity. For example, it may become blurry and visually difficult to read when the relative humidity of the environment is too high or too low. The humidity dependency of the electrochromic display not only degrades its performance but also limits the fields of applications to environments where the relative humidity is optimal (i.e. not too dry or too humid).

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

It is an object of the present disclosure to provide an improved electrochromic display which eliminates or alleviates at least some of the disadvantages of humidity-sensitive electrochromic displays.

Embodiments of the present invention relate to an encapsulated electrochromic display and methods for making and using the same. By encapsulating the electrochromic display after conditioning (e.g., introducing moisture or water into the electrochromic display), a proper relative humidity can be achieved and maintained within the environment in the encapsulation. The encapsulated electrochromic display functions properly substantially regardless of the humidity of the surrounding environment outside of the encapsulation.

One aspect of the present disclosure relates to an encapsulated electrochromic display. The electrochromic display (ECD) comprises first and second electrodes and an electrochromic layer between the first and second electrodes. The electrode(s) and electrochromic layer may be printed. The encapsulation comprises a first, optically transparent encapsulation layer and a second encapsulation layer. Each of the first and second encapsulation layers may have length and width dimensions greater than those of the first and second electrodes and the electrochromic layer, and the length and width dimensions of the first encapsulation layer may be greater than those of the second encapsulation layer.

The first and second encapsulation layers are generally on opposite sides or surfaces of the electrochromic display, such that the first and second encapsulation layers encapsulate the electrochromic display. At least one of the first and second electrodes comprises a material having an air or water vapor permeability sufficient to allow water vapor to permeate the electrochromic layer during a roll-to-roll printing process. The electrochromic layer may include a predetermined minimum amount of water or moisture therein, and at least one of the first and second encapsulation layers are optically transparent. For example, the predetermined minimum amount of water or moisture content of the electrochromic display is equilibrated to an atmosphere with a relative humidity (RH) of from 20% to 55% (and, for example, a temperature of 15-30° C.) before encapsulation. In some embodiments, the equilibration is done in an environment having a relative humidity of from 45% to 55%. The time needed to equilibrate the moisture level inside the display in an atmosphere with a particular relative humidity is called the conditioning time. At least one of the electrodes may comprise carbon having a porosity and/or permeability suitable for transporting moisture (e.g., water vapor) through the electrode and into the electrochromic layer, to reduce the conditioning time of the electrochromic display. The first and second encapsulation layers encapsulate the electrochromic display so that the water or moisture content of the electrochromic layer and/or electrochromic display can remain at a predetermined and/or optimal level. Optionally, the encapsulation further comprises an adhesive between the first and second encapsulation layers (e.g., on the sides or surfaces of the first and second encapsulation layers facing each other).

The first and second encapsulation layers may each independently comprise a flexible material and/or a moisture barrier layer. The moisture barrier layer is advantageous since it can enclose or preserve water or moisture inside the encapsulation and thus and prevent water or moisture evaporating from the encapsulation to the outside. It can also prevent water or moisture from entering into the encapsulation from the outside. Thus, an environment with a desired moisture level or relative humidity inside the encapsulation may be provided for the electrochromic display. The present encapsulated electrochromic display can function properly regardless of the relative humidity of the surrounding environment outside the encapsulation. The moisture barrier layer(s) may also exhibit other barrier characteristics (e.g., against oxygen and acid). The flexible material is also advantageous since it can, for instance, be adapted for roll-to-roll processing.

The flexible material may be or comprise a polymer film. The polymer film may be or comprise, for instance, a polyethylene terephthalate (PET) film. The polymer film may further comprise or have a barrier layer thereon. According to one or more alternative embodiments, the flexible material may be a thin metal foil. The metal foil may be or comprise, for instance, an aluminum or stainless steel foil.

The flexible material may further comprise a non-conductive coating on at least one side thereof. Since the flexible material itself may be conductive or non-conductive, a non-conductive coating on at least the side of the flexible material (which may also function as a moisture barrier layer) facing the electrochromic display ensures that at least the side or surface of the flexible material that is in contact with the electrochromic display is not conductive. The electrochromic display therefore functions properly, even though the flexible material may be conductive (e.g. in the case of a metal foil). The non-conductive coating may comprise one or more oxides (e.g., silicon dioxide or a metal oxide). As a result, both the metal foil and the polymer film may be coated with an oxide insulator in order to provide a non-conductive surface on the flexible material.

Further, the first and the second encapsulation layers may comprise or be made from the same or different materials.

At least one electrode (e.g., the second electrode) is adapted to transport moisture into the electrolyte of the electrochromic display. Having an electrode which is permeable to moisture (e.g., water) allows for the transport of moisture into the electrolyte, so that it is possible to provide a fast conditioning step after printing and drying the electrochromic display, and before encapsulating and sealing the electrochromic display with the second (e.g., moisture barrier) layer. Since the drying process removes moisture from the electrolyte and/or the electrode, the conditioning step can add moisture into the electrolyte if it is too dry. Alternatively, if the electrolyte has too much moisture, then a permeable electrode allows additional drying, as needed. In both cases, the moisture-permeable electrode allows conditioning of the electrochromic display to the proper humidity or moisture level before sealing with the second encapsulation layer.

The moisture-permeable electrode may comprise or be made of a porous, non-porous or substantially non-porous material. If the material is non-porous or substantially non-porous, the moisture-permeable electrode(s) may further comprise a porous material (for instance, a polymer or binder in the electrode material) to increase the moisture transmission rate (e.g., the speed with which moisture is transported through the electrode and into the electrolyte of the electrochromic display).

The moisture-permeable electrode may comprise or be made of carbon. The carbon may be porous, non-porous or substantially non-porous. The carbon electrode may be optimized for transporting moisture through the electrode layer and into the electrolyte to reduce the conditioning time of the electrochromic display. Accordingly, when the carbon electrode is non-porous or substantially non-porous, it may further comprise a porous binder (e.g., a porous polymer) that has a water permeability greater than a predetermined minimum permeability.

Furthermore, the encapsulated electrochromic display may include one or more first traces or leads electrically connected to the first electrode and one or more second traces or leads electrically connected to the second electrode. The second traces or leads are electrically isolated from the first traces or leads, and at least a part of each of the first and second traces or leads may be exposed by the second encapsulation layer.

The present encapsulated electrochromic display operates independently from the relative humidity of the environment where it is used. Thus, the present encapsulated electrochromic display can be used reliably in various external (outdoor) and internal (indoor) environments.

Another aspect of the present disclosure relates to a method for encapsulating an electrochromic display, comprising forming the electrochromic display on a first encapsulation layer, conditioning the electrochromic display in an environment having a predetermined minimum water vapor therein, and applying a second encapsulation layer on the electrochromic display, such that the first and second encapsulation layers encapsulate the electrochromic display. The electrochromic display includes at least a first electrode, a second electrode, and an electrochromic layer between the first and second electrodes. At least one of the first and second encapsulation layers and/or at least one of the first and second electrodes is optically transparent. For example, the first electrode may be optically transparent. At least one of the electrodes (e.g., the second electrode) is formed by a roll-to-roll printing process and comprises a material having an air or water vapor permeability sufficient to allow water vapor to permeate the electrochromic layer during the roll-to-roll printing process. For example, the electrode(s) may comprise carbon, which can have a porosity and/or permeability suitable for transporting moisture (e.g., water vapor) through the electrode and into the electrochromic layer to provide the electrochromic layer with a predetermined minimum amount of water or moisture therein and reduce the conditioning time of the electrochromic display. In some embodiments, conditioning the electrochromic display results in the electrochromic layer containing water in an amount equilibrated to an atmosphere with a relative humidity is in the range of from 20% to 55% (e.g., 45% to 55%), and optimally, in which the environment has a temperature of 15-30° C. The first and second encapsulation layers may be or comprise moisture barrier layers.

The second encapsulation layer may be applied to the first encapsulation layer by adhesion (e.g., adhering the second encapsulation layer to the first encapsulation layer using an adhesive). Alternatively, the second encapsulation layer may be applied to the first encapsulation layer by lamination or printing (e.g., laminating or printing the second encapsulation layer on the electrochromic display and the first encapsulation layer and/or laminating the second encapsulation layer, the electrochromic display and the first encapsulation layer).

The present method may comprise or be conducted by roll-to-roll processing. In addition to the first and/or second electrodes being formed by a roll-to-roll printing process, the electrochromic layer, one or more traces in contact with the first and/or second electrodes, and/or the second encapsulation layer can be formed by roll-to-roll printing.

At least one electrode (e.g., the second electrode) is water-permeable (e.g., be able to transport moisture into the electrolyte of the electrochromic display). Thus, the method comprises conditioning the electrochromic display (e.g., passing moisture or water through the one or more electrodes) before encapsulating the electrochromic display (e.g., applying the second encapsulation layer).

The water-permeable electrode may comprise or be made from a porous or a non-porous material. For example, the water-permeable electrode (e.g., the second electrode) may comprise or be made from carbon. In various embodiments, the carbon may be graphite and/or carbon black. It is thus possible to use a carbon-containing ink when printing the electrode(s) of the electrochromic display. For example, forming the second electrode may include printing an ink that may comprise the carbon, a binder and a solvent to form the second electrode.

In addition, the method of encapsulating the electrochromic display may include forming a first trace or lead electrically connected to the first electrode, and forming a second trace or lead electrically connected to the second electrode. Furthermore, the encapsulated electrochromic display may be affixed or mounted to a substrate, and the ends of the first and second traces or leads may be exposed through openings or windows in the substrate. Forming the electrochromic display may further include printing a first ink on the first encapsulation layer to form the first electrode, printing a second ink on the first electrode to form the electrochromic layer, and printing a third ink on the electrochromic layer to form the second electrode.

Effects and features of the present method are largely analogous to those described above in connection with the present encapsulated electrochromic display. These and other advantages of the present invention will become readily apparent from the detailed description of various embodiments below.

### BRIEF DESCRIPTION OF THE DRAWINGS

FIG. 1 is an exploded perspective view of various layers in an exemplary encapsulated electrochromic display in accordance with one or more embodiments of the present invention.

FIG. 2 is a top view of an exemplary encapsulated electrochromic display in accordance with one or more embodiments of the present invention.

FIG. 3 is a top view of an exemplary sheet of the encapsulated electrochromic displays of FIG. 2 in accordance with one or more embodiments of the present invention.

FIG. 4 is a rear view of an exemplary sheet of encapsulated electrochromic displays in accordance with one or more further embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the terms “moisture” and “water” are generally used interchangeably herein, and use of one such term generally includes the other. Also, for convenience and simplicity, the terms “connected to,” “coupled with,” “coupled to,” and “in communication with,” but these terms are generally given their art-recognized meanings.

The invention, in its various aspects, will be explained in greater detail below with regard to exemplary embodiments.

An Exemplary Method of Forming an Encapsulated Electrochromic Display

FIG. 1 illustrates an exemplary electrochromic display on a first encapsulation layer 10. The electrochromic display further comprises a first (e.g., lower) electrode 11, an electrochromic layer 12, a second (e.g., upper) electrode 13, and a second encapsulation layer 20. The first electrode 11 has a first trace 14 extending therefrom, and the second electrode 12 has a second trace 15 extending therefrom. The second trace 15 does not overlap the first trace 14.

The first encapsulation layer 10 may be optically transparent and may function as a substrate on which the remaining layers of the electrochromic display are formed and/or placed. The first encapsulation layer 10 is generally impermeable to moisture, oxygen, and the materials of the first electrode 11 and the electrochromic layer 12.

The first electrode 11 generally comprises a transparent conductive material, such as a transparent metal oxide (e.g., indium tin oxide [ITO]), a transparent conductive polymer (e.g., poly(3,4-ethylenedioxythiophene) [PEDOT] or poly(3,4-ethylenedioxythiophene) :poly(styrene sulfonate) [PEDOT:PSS]), a thin metal layer or metal grid (e.g., of aluminum, silver, zinc, etc.), or carbon nanotubes. The first electrode 11 has dimensions smaller than first encapsulation layer 10, and in general sufficiently small to enable formation of the trace 14 on the first encapsulation layer 10. The first electrode 11 may be formed by printing (e.g., screen printing, inkjet printing, or gravure printing in a roll-to-roll process, etc.) or by thin-film processing (e.g., blanket deposition, such as chemical vapor deposition or sputtering, and patterning using an etching mask). The first electrode 11 may comprise a single layer or multiple layers, and may be a single structure or comprise a plurality of separate parts or sections, each with a unique trace (which may be electrically connected to the trace[s] to the other part[s] or section[s]).

The first trace 14 generally comprises a conductor, such as a metal film (e.g., comprising aluminum, titanium, nickel, zinc, silver, copper, gold, palladium, etc.), a conductive polymer, or a conductive carbon film. The first trace 14 contacts the first electrode 11, and has dimensions enabling subsequent formation of the second trace 15 in contact with the second electrode 13, but such that the second trace 15 cannot overlap or come into contact with the first trace 14. The first trace 14 may be formed by printing or thin-film processing, as described herein.

If desired, an optical mask may be printed on or over the first electrode. The optical mask may include a pattern therein, such as one or more letters, words, images, icons, etc., that is viewable when the electrochromic display is on.

The electrochromic layer 12 generally comprises an electrochromic material and an electrolyte. The electrochromic material may comprise an inorganic electrochromic material (e.g., a hexacyanoferrate salt or complex, a tungsten oxide, etc.) or an organic electrochromic material (e.g., a bipyridinium salt such as ethyl viologen, a bianthrone, etc.). The electrochromic layer 12 may further comprise an ion storage layer and/or an interface layer (e.g., comprising doped and/or porous titania) between the electrochromic layer and the first electrode 11. The electrochromic layer 12 generally has length and width dimensions the same as or slightly smaller than those of the first electrode 11, but in general sufficient to space the second electrode 13 apart from the first electrode 11 without extending beyond the peripheral borders of the first electrode 11. The electrochromic layer 12 may be formed on the first electrode 11 by printing (e.g., in a roll-to-roll process), coating (e.g., slot die coating) or thin-film processing, as described herein.

The second electrode 13 generally comprises or is made of a conductive material, in a form that allows for the electrode 13 to be permeable to moisture, thus allowing moisture to be readily and quickly transported into the electrolyte in the entire electrochromic layer 12. The conditioning time for the electrochromic display may be thus be greatly reduced, which is important in roll-to-roll processing for manufacturing the electrochromic display. Thus, in various embodiments, the second electrode 13 is formed by printing in a roll-to-roll process (e.g., rotary screen printing, etc.).

Roll-to-roll printing processes may include rotary screen printing, gravure printing, intaglio printing, inkjet printing, other screen printing, flexography, offset lithography, stamp printing (or letterpress printing), wax jet printing and electrographic printing. These processes are discussed in more detail below.

In rotary screen printing, a relatively high viscosity ink (e.g., having a viscosity of 1000 cP to 10,000 cP) may be used for printing of lines or patterns. The viscosity is often a result of high mass loading of particles, pigments, etc. in the ink. For example, the total mass loading of solid-phase materials in the rotary screen printing ink may be 10-90 wt.%, or any value or range of values therein (e.g., 20-50 wt.%). Therefore, rotary screen printing may deposit both large wet thicknesses as well as large dry thicknesses (e.g., 2-10 microns) of material.

The ink may be UV curable and/or solvent-based, and the solvent may comprise water and/or one or more organic solvents having a moderately slow or slow drying time and /or evaporation rate. As a result, rotary screen printing is suitable for moderately fast roll-to-roll printing, typically at speeds in the range of 30-100 meters/minute (or any speed/rate or range of speeds or rates therein). Rotary screen printing is suitable for both absorbing and non-absorbing substrates such as paper and plastics including, for example, polyethylene terephthalate (PET).

In roll-to-roll gravure printing, a low to medium viscosity ink (e.g., having a viscosity of 10 cP to 300 cP) may be used for printing lines or patterns having a low wet thickness (e.g., 1-5 microns) and/or to improve or enhance long-term and run-to-run repeatability, as well as printing relatively narrow lines and/or patterned areas or blocks. The ink may comprise an alcohol solvent (e.g., a C₁-C₁₂ aliphatic alcohol) with one or more optional solvents, all of which may have fast or moderately fast drying times and/or evaporation rates. As a result, gravure printing may be suitable for high-speed roll-to-roll printing, at speeds up to, e.g., 100-500 meters/minute. While roll-to-roll gravure printing may be used on absorbent and non-absorbent substrates, gravure printing is particularly useful when the substrate comprises a plastic (e.g., polyethylene naphthalate [PEN] or polyethylene terephthalate [PET]). Intaglio printing is somewhat similar to gravure printing, but may produce lines and patterns on non-absorbent substrates that are less consistent and/or reproducible than those produced by gravure printing.

Inkjet printing generally benefits from inks and/or solvent systems having a surface tension optimized for inkjet printing and a slower evaporation profile than those used in gravure printing. However, inkjet printing may not be ideal for high-speed, high-throughput mass production due to jet clogging. Screen printing generally benefits from inks having a higher viscosity and/or higher coating weight than those used in gravure printing. Flexographic printing (and, similarly, stamp/letterpress printing) generally benefit from inks and/or solvent systems having a higher viscosity than those used in gravure printing, and may be less ideal than gravure printing for high-throughput mass production due to wear-and-tear on the printing plate, stamp or press.

Offset lithographic printing also generally benefits from inks and/or solvent systems having an optimized surface tension and a higher viscosity range than those used in gravure printing, due to the open nature of the multiple rollers used in offset lithographic printing. Electrographic printing uses solid toners, rather than wet inks, and therefore may not be suitable for printing certain materials. Electrographic printing benefits from a consistent and/or uniform substrate surface resistivity, Wax-jet printing is generally useful for printing relatively thick layers (e.g., on the order of 5-10 microns or more), and therefore may not be suitable for manufacturing thin ECDs.

In one embodiment, the electrode 13 may comprise or be made from a porous conductive material. Alternatively, in other embodiments, the electrode 13 may comprise or be made from a non-porous or substantially non-porous conductive material. The electrode 12 may further comprise a binder which is relatively polar (e.g., poly(ethylene:vinyl acetate) [EVA], poly(vinylidene difluoride) [PVDF] and copolymers and blends thereof, a polyacrylate such as poly(methyl acrylate) [PMA] and copolymers and blends thereof, a polymethacrylate such as poly(methyl methacrylate) [PMMA] and copolymers and blends thereof, etc.). The binder may increase the moisture transmission rate (e.g., the speed with which moisture is transported into the electrochromic layer 12 and/or the electrolyte therein) relative to the conductive material alone.

In one embodiment, the material for the upper electrode 13 may be or comprise carbon. A carbon electrode may be optimized for reducing the conditioning time of the electrolyte in that it can be adapted to allow moisture transport through the electrode and into the electrochromic layer 12 and/or the electrolyte. The material for the upper electrode 13 may alternatively be any other suitable material.

Some parameters of the carbon material can be used to describe and/or characterize the water transmission rate (e.g., air and/or moisture permeability) through the carbon electrode. These parameters may include porosity, particle size, pore volume and/or pore diameter. One standard (but not limiting) definition of porosity (ASTM standard C709) related to manufacturing of carbon and graphite is the percentage of the total volume of a material occupied by both open and closed pores. This definition (as well as other general or material-specific definitions) may be applicable to other materials. Conductive carbon inks, for example, comprise electrically conductive carbon black or graphite. The particle size for carbon black used in example inks to make the electrodes 13 and traces 15 is approximately 0.02 μm, although carbon black normally agglomerates to form larger particles. The particle size of graphite used in similar or otherwise identical example inks was 10-20 μm.

However, comparisons of air and/or moisture permeability for films formed from different inks is often complex, since they are typically formulated using different binders or binder systems. The absolute values of pore diameters and pore volumes of the porous materials (i.e., the definition or characterization of the porous materials) depend for example on the selection of each material and its concentration in the formulation to be deposited (e.g., the specific material and/or type of binder, etc.).

The pore diameter and pore volume for carbon black were determined to be 0.02 μm and 2 mL/g, respectively. For graphite, the pore diameter and pore volume were determined to be 0.7 μm and 1 mL/g, respectively. The permeability coefficient was 50% higher for graphite compared to carbon black. Larger pores are believed to be beneficial for high moisture and/or air permeability.

The thickness of the carbon film or layer forming the upper electrode 13 may be in the range of from 3 to 7 μm, and is in one example around 5 μm. These thicknesses allow for an efficient transport of moisture or water during a conditioning step, while still allowing for roll to roll processing of the encapsulated display and the layers thereof. The moisture and/or air permeability of this carbon film or layer can be optimized to facilitate conditioning of the display in a high-volume roll-to-roll compatible manufacturing process, meaning that the conditioning is sufficiently fast so as to not dramatically or significantly reduce the overall manufacturing throughput using a printer (e.g., a screen printer, inkjet printer or gravure printer).

Conditioning the electrochromic layer 12 and/or the electrolyte therein is a step that occurs after printing the electrochromic layer 12 and/or the upper electrode 13. Any moisture removed from the electrochromic layer 12 and/or the electrolyte in a drying process (e.g., following printing the electrochromic layer 12 and/or the upper electrode 13) is replaced by adding moisture back into the electrochromic layer 12 and/or the electrolyte. Alternatively or additionally, a predetermined or desired level or concentration of moisture or water may be added to the electrochromic layer 12 and/or the electrolyte when the level or concentration of moisture or water is less than the predetermined or desired level. The amount or concentration of water in the electrolyte affects the performance of the electrochromic display, and the addition of moisture or water should be controlled. One solution is to condition the electrochromic display in a controlled environment. For example, the electrochromic display may be conditioned by exposing the electrochromic display (e.g., the electrochromic layer 12 and/or the second electrode 13 thereon) to an environment having a relative humidity (RH) of from 20% to 55%, or any RH or RH range between 20% and 55%. The conditioning environment should also have a predetermined (e.g., controlled) temperature, for example from 15° C. to 30° C., or any temperature or temperature range between 15° C. and 30° C. In one embodiment, the conditioning environment has a temperature of 25° C. and a relative humidity of 45%.

It is within the skill of one skilled in the art to determine the amount of water introduced into the electrochromic layer 12 under known environmental conditions (i.e., the “amount equivalent to a relative humidity”), where such conditions include temperature, electrochromic material and/or electrolyte composition, and/or water permeability of the second electrode, in addition to the RH. For example, the mass of the ECD before and after conditioning (e.g., after formation of electrodes 13 and traces 15, but prior to encapsulation) can be determined to calculate the mass of water in the ECD. The amount of water introduced into the electrochromic layer 12 is generally a trace amount (e.g., from 0.04 mg to 3 mg per cm², or any value or range of values therein, such as 0.1-1 mg/cm²). When the upper electrode 13 comprises carbon (e.g., porous carbon), the amount of water introduced into the electrochromic layer 12 may be from 0.2 mg to 0.6 mg per cm², or any value or range of values therein (in one example, about 0.3 mg/cm²). The physical and chemical properties of the electrochromic layer 12, the electrolyte and/or the second electrode 13 may be optimized to facilitate fast conditioning under the controlled conditions. However, the amount of water introduced into the electrochromic layer 12 is material-specific (and may be somewhat thickness-specific), and other combinations of materials for the electrode 13 and electrochromic layer 12 (and, optionally, the trace 15 and/or the thickness[es] of the electrode 13 and electrochromic layer 12) may have a different acceptable window or range of water content.

The second electrode 13 may be formed on the electrochromic layer 12 by roll-to-roll printing or, in embodiments where the first electrode 11 is porous and printed in a roll-to-roll process, thin-film processing, as described herein. When the second electrode 13 is printed, it may be printed using a carbon ink. The carbon ink may comprise (i) carbon black, carbon nanotubes and/or graphite, (ii) a binder, and (iii) a solvent. Conditioning may thus comprise transporting water or moisture (e.g., in the form of water vapor in the air) through the printed upper electrode 13 comprising carbon and the binder. The invention thus also relates to identifying a suitable carbon source (e.g., carbon black, carbon nanotubes or graphite) and/or a suitable binder to facilitate fast transport of moisture or water. A carbon electrode that facilitates fast water transport may be porous or substantially non-porous, and may comprise a content or proportion of graphite relative to carbon black of at least 1:1 (e.g., at least 3:2, 3:1, or any ratio greater than 1:1) by weight or volume.

The second electrode 13 has dimensions smaller than the first electrode 11. Typically, the first electrode 11 completely overlaps (and thus has length and width dimensions greater than) the second electrode 13.

The upper electrode 13 (and the lower electrode 11) may also affect the switching properties of the electrochromic display. The electrochromic display may also function as a battery, which can affect the performance of the electrochromic display (e.g., the optical contrast in the ON and OFF states). The performance of the electrochromic display (e.g., the optical contrast) should be considered when selecting the material for the upper electrode 13.

The second trace 15 generally comprises a conductor, such as a metal film as described above, and can be the same as or different from the first trace 14. The second trace 15 contacts the second electrode 13, and has dimensions that enable the second trace 15 to not overlap or come into contact with the first trace 14. The second trace 15 may be formed by printing (e.g., in a roll-to-roll process) or thin-film processing, as described herein. The contact leads (e.g., traces 14 and 15) extending away from the electrodes 11 and 13 are generally not involved in conditioning.

After the conditioning step, the electrochromic display is encapsulated with a barrier material (e.g., the second encapsulation layer 20). The second encapsulation layer 20 has dimensions (e.g., a length and a width) greater than those of the electrodes 11 and 13 and the electrochromic layer 12. The second encapsulation layer 20 is applied on or to the electrochromic display (e.g., by printing or adhering) over the upper electrode 13 to encapsulate the display. The second encapsulation layer 20 can expose the distal ends of the traces or leads 14 and 15 (i.e., from the electrodes 11 and 13). Alternatively, the second encapsulation layer 20 can also encapsulate the traces or leads 14 and 15, if openings are subsequently formed in the first encapsulation layer to expose the distal ends of the traces or leads 14 and 15.

The first encapsulation layer 10 and second encapsulation layer 20 may be or comprise moisture barrier layers. They may be able to enclose or preserve water or moisture inside the encapsulation. They may also be able to prevent water or moisture entering into the encapsulation from the outside and to prevent water or moisture evaporating from inside the encapsulation to the outside. Thus, a desired water or moisture content or concentration may be provided inside the encapsulation for the encapsulated electrochromic display. The encapsulated electrochromic display can thus function properly and reliably, regardless of the relative humidity of the surrounding environment outside of the encapsulation.

In one or more embodiments, the first encapsulation layer 10 and the second encapsulation layer 20 may comprise or be made of a flexible material. They can also be adapted for roll to roll processing, as described herein. In one embodiment, the first encapsulation layer 10 and the second encapsulation layer 20 may also exhibit other barrier characteristics (e.g., oxygen and/or acid barrier properties).

In one or more embodiments, the material of the first encapsulation layer 10 and the second encapsulation layer 20 may comprise or be a non-conductive material. The non-conductive material may be or comprise a polymer film. The polymer film may comprise or be made of, for instance, a polyethylene terephthalate (PET) film. This film may function as a barrier material, or alternatively, the first and/or second encapsulation layers 10 and 20 may further comprise or be provided with a barrier film or layer.

In one or more embodiments, the material of the first encapsulation layer 10 and the second encapsulation layer 20 may be or comprise a conductive material. The conductive material may be or comprise a thin metal foil, especially in the case of the second encapsulation layer 20, as the first encapsulation layer 10 is generally optically transparent. The metal foil may be or comprise, for instance, an aluminum, titanium, copper, or stainless steel foil.

In one or more embodiments, the material of the first encapsulation layer 10 and the second encapsulation layer 20 may include or be provided with a non-conductive coating on at least one side. Since the material of the first encapsulation layer 10 and/or the second encapsulation layer 20 may be conductive or non-conductive, by providing a non-conductive coating on at least the sides of the first encapsulation layer 10 and the second encapsulation layer 20 facing the electrochromic display, at least the sides which are in contact with the electrochromic display are not conductive. Such a non-conductive coating may comprise, e.g., an inorganic insulator such as silicon dioxide, a metal oxide such as aluminum oxide, or a mixture or combination thereof, or an organic insulator such as PET, polyethylene, polyvinyl chloride (PVC), polyvinylidene dichloride, a polyfluoroalkene such as polytetrafluoroethylene, polytrifluoroethylene, or polydifluoroethylene, a copolymer and/or blend thereof, etc. Proper and reliable function of the electrochromic display, even though the material of the first encapsulation layer 10 and/or the second encapsulation layer 20 may be conductive (e.g. in the case of an aluminum foil), can be achieved. In various embodiments, the first encapsulation layer 10 and the second encapsulation layer 20 may comprise or be made from the same or different materials. In one embodiment, the second encapsulation layer 20 may be optically transparent, although this is not necessary as the second encapsulation layer 20 is generally not visible to the viewer or user.

A moisture barrier layer is a layer used for preventing moisture from passing through. In the present application, a flexible material can also be a moisture barrier, or alternatively further comprise or be provided with a moisture barrier layer. However, many materials suitable as a moisture barrier layer are not perfectly moisture proof, as they can have varying degrees of water permeability. Thus, the water vapor transmission rate (WVTR) of a material can describe or characterize the moisture barrier property of the material. Some materials suitable as a moisture barrier layer are listed in Table 1 below. The WVTR is given as a range since the actual value can depend on a number of factors, such as the thickness of the material, the presence and properties of any coating thereon, the environmental conditions, etc. Other materials not listed in Table 1 may also be suitable as a moisture barrier layer.

TABLE 1
Moisture barrier materials

| Material | WVTR [g/m²/day] |
|---|---|
| Polypropylene | 0.1-10 |
| Al coated with PE | 10⁻¹-10⁻² |
| PET + AlOₓ | 10⁻¹-10⁻² |
| Polyvinylidene dichloride | 10⁻¹-10⁻² |
| Cyclic olefin copolymers | 10⁻¹-10⁻² |
| Polychlorotrifluoroethene | 10⁻¹-10⁻² |
| PET + SiO₂ | 10⁻²-10⁻³ |

Exemplary Encapsulated Electrochromic Displays

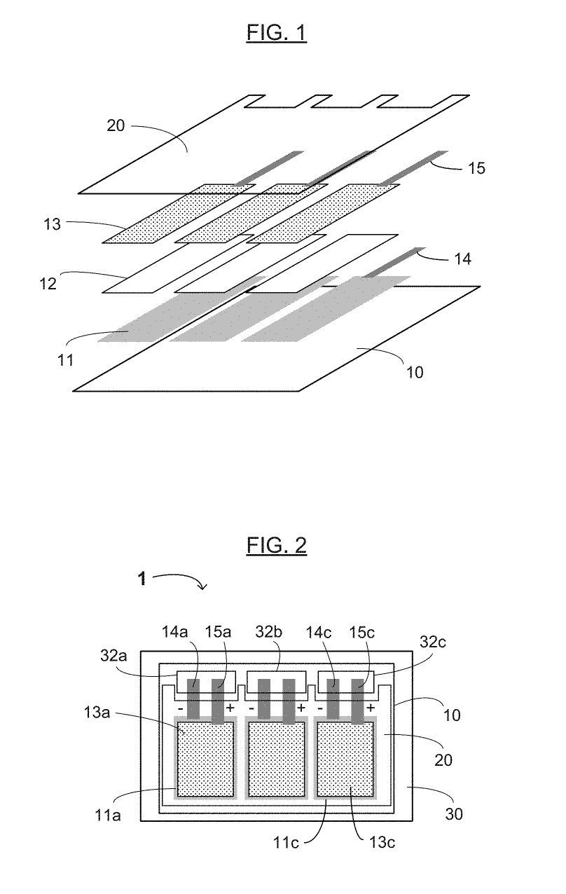

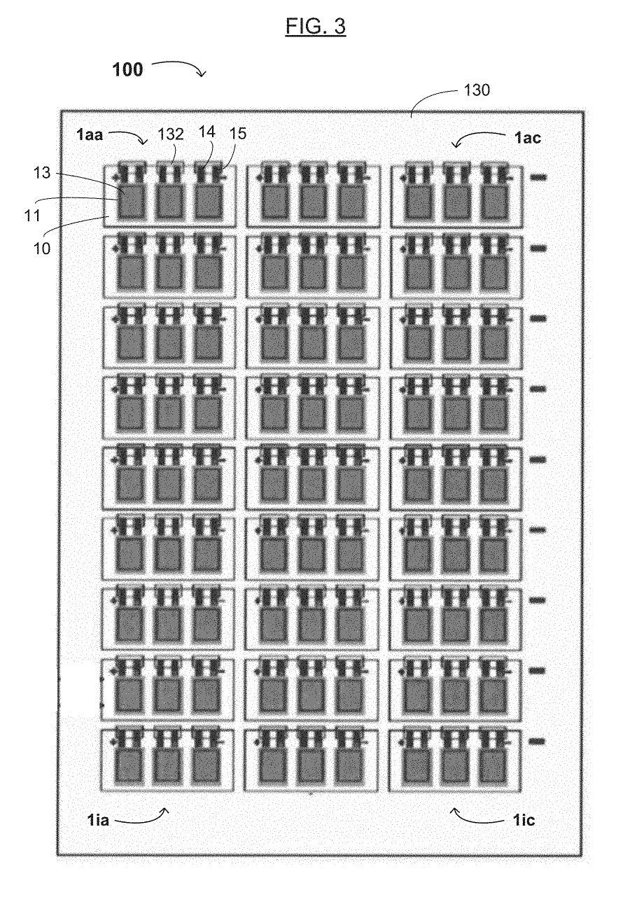

In another aspect, the present invention concerns an electrochromic display encapsulated between first and second encapsulation layers, such as the exemplary electrochromic display 1 of FIG. 2. The exemplary encapsulated electrochromic display 1 of FIG. 2 includes first and second electrodes 11a-c and 13a-c, respectively, first and second traces 14a-c and 15a-c, respectively, the electrochromic layer (not shown), and the first and second encapsulation layers 10 and 20. The encapsulated electrochromic display 1 shown in FIG. 2 is substantially the encapsulated electrochromic display of FIG. 1, mounted on or affixed to a substrate 30 with openings or windows 32a-c therein.

FIG. 2 illustrates a bottom view of the encapsulated electrochromic display 1 (i.e., with the second electrode 13 facing toward the viewer). The substrate 30 is thus the structure closest to the viewer in FIG. 2. The substrate 30 may comprise a transparent film or sheet of paper, a polymer (e.g., a polyester such as PET or a silicone film), a metal foil, or a combination or laminate thereof (e.g., a release film or liner). The substrate 30 has length and width dimensions greater than those of the first encapsulation layer 10.

To mount or affix the encapsulated electrochromic display of FIG. 1 on or to the substrate 30, an adhesive can be applied to the periphery of the encapsulated electrochromic display (e.g., the periphery of the first encapsulation layer 10), and the encapsulated electrochromic display is pressed against the substrate 30. The adhesive may be or comprise a poly(meth)acrylate adhesive or other adhesive as is known in the art.

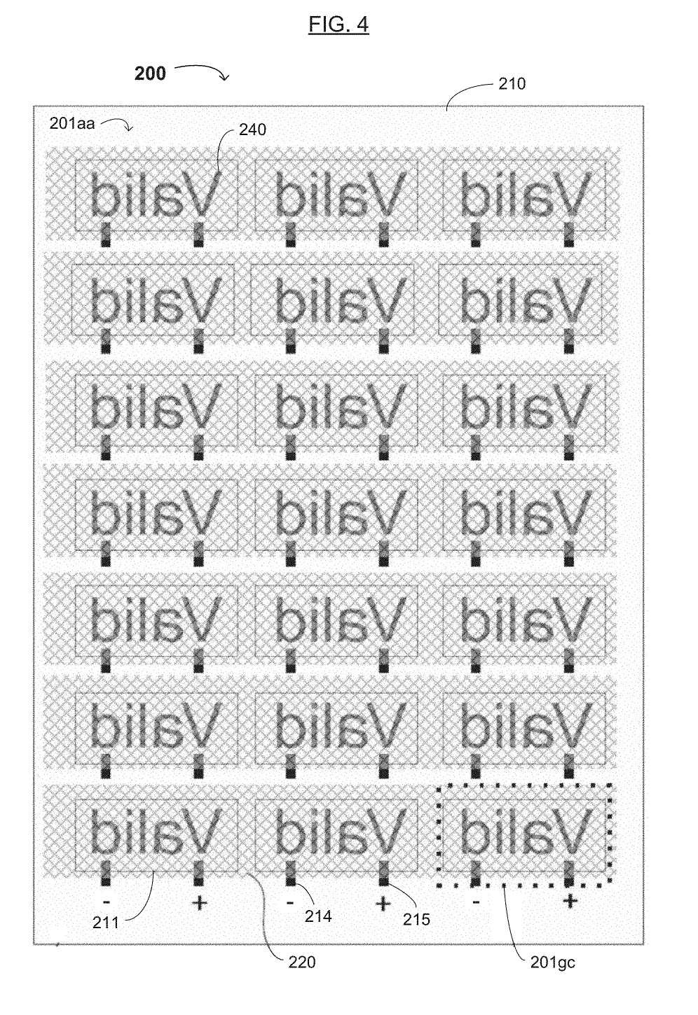

FIG. 3 illustrates an array 100 of electrochromic displays laa-lic on a release sheet 130. Each of the electrochromic displays 1aa-1ic comprises first and second electrodes 11 and 13, respectively, first and second traces 14 and 15, respectively, the electrochromic layer (not shown), the first encapsulation layer 10 and the second encapsulation layer (not shown). The release sheet 130 has a plurality of openings or windows 132 exposing distal ends of the first and second traces 14 and 15.

The electrochromic displays 1aa-1ic may be printed on the first encapsulation layer 10 prior to placement on the release sheet 130. As described herein, the encapsulated electrochromic displays 1aa-1ic may be mounted on or affixed to the release sheet 130 using an adhesive applied to the periphery of the encapsulated electrochromic display (e.g., the periphery of the first encapsulation layer 10), other than locations overlapping the openings 132. The adhesive may be applied to areas of the first encapsulation layer 10 and/or the second encapsulation layer (not shown) that contact areas of the release sheet 130 adjacent to the openings 132.

The release sheet 130 may be adapted for roll-to-roll processing (e.g., during placement and/or formation of the electrochromic displays 1aa-1ic on the release sheet 130) and/or pick-and-place processing (e.g., during subsequent removal of the electrochromic displays 1aa-1ic from the release sheet 130 and placement on a separate substrate or item). Thus, in one or more embodiments, the release sheet 130 may comprise a polymer (e.g., a polyester such as PET) film or sheet with a layer thereon adapted to reduce adhesiveness of the polymer (e.g., a “non-stick” layer such as a polysilicone or poly[di-, tri- and/or tetrafluoroethylene] film). In addition, the release sheet 130 may have perforations between each of the electrochromic displays 1aa-1ic to facilitate removal and subsequent placement of the electrochromic displays 1aa-1ic.

As described herein, the second encapsulation layer (not shown in FIG. 3) is applied to the electrochromic displays 1aa-1ic, such that the electrochromic displays 1aa-1ic are encapsulated between the first encapsulation layer 10 and the second encapsulation layer. At least a part of the first traces 14 (e.g., the ends of the positive electrodes exposed through the openings 132) and a part of the second traces 15 (e.g., the ends of the negative electrodes exposed through the openings 132) are not encapsulated.

FIG. 4 shows an exemplary sheet 200 of the encapsulated electrochromic displays 201aa-201gc configured to display a message (e.g., “Valid”) when the electrochromic display is on. Thus, each of the encapsulated electrochromic displays 201aa-201gc further comprises an optical mask 240 having a pattern in the form of the message to be displayed.

In the sheet 200 of FIG. 4, the first encapsulation layer 210 also functions as the substrate (e.g., for roll-to-roll processing of the electrochromic display elements, such as printing the first electrode 211, the optical mask 240, the electrochromic material [not shown], the second electrode [not shown], and the first and second traces 214 and 215) and/or release sheet (e.g., for subsequent pick-and-place processing). After formation of the electrochromic display elements on the first encapsulation layer 210, the second encapsulation layer 220 is formed on or affixed to the first encapsulation layer 210 and over the electrochromic display elements to encapsulate the electrochromic displays. Parts (e.g., the distal ends) of the first and second traces 214 and 215 are exposed (i.e., not covered) by the second encapsulation layer 220. The non-encapsulated parts of the first and second traces 214 and 215 may be used for testing and/or further assembly (e.g., electrical connection to a power source and ground plane in another device).

In one or more embodiments, the encapsulated electrochromic displays 201aa-201gc can be removed along perforated lines, as shown in FIG. 4.

An Exemplary Method of Encapsulating an Electrochromic Display

FIGS. 1-4 also illustrate method for encapsulating an electrochromic display, comprising forming the electrochromic display on a first encapsulation layer, conditioning the electrochromic display in an environment having a relative humidity of from 20% to 55%, and applying a second encapsulation layer on or to the electrochromic display such that the first and second encapsulation layers encapsulate the electrochromic display. The electrochromic display comprises at least a first electrode, a second electrode, and an electrochromic layer between the first and second electrodes. At least one of the first and second encapsulation layers is optically transparent.

Forming the electrochromic display may comprise printing one or more electrochromic display layers on the first encapsulation layer. In various embodiments, the first electrode is printed on the first encapsulation layer, the electrochromic layer is printed on the first electrode, and/or the second electrode is printed on the electrochromic layer. Forming the electrochromic display may comprise printing one or more traces or leads to each of the first and second electrodes. The traces or leads may be printed simultaneously with the corresponding electrode, in which case the trace(s) or lead(s) and the corresponding electrode comprise the same material(s), or prior to or after printing (or otherwise forming) the corresponding electrode, in which case the trace(s) or lead(s) and the corresponding electrode may comprise different materials.

Conditioning the electrochromic display takes place before encapsulating the electrochromic display with the second encapsulation layer (i.e., applying the second encapsulation layer on or to the electrochromic display). The electrochromic display is conditioned after forming the electrochromic layer, and generally, after forming the second electrode and the trace(s) or lead(s) thereto.

In one or more embodiments, the second encapsulation layer is applied to the first encapsulation layer by adhering the second encapsulation layer to the first encapsulation layer. For example, an adhesive (e.g., a water-impermeable adhesive) is applied to the periphery of the second encapsulation layer, then the second encapsulation layer with the adhesive thereon is placed onto the first encapsulation layer and pressure is applied to the first and second encapsulation layers to form a watertight seal around the electrochromic display. The adhesive is generally applied to the side or surface of the second encapsulation layer facing the first encapsulation layer. Alternatively, the adhesive may be applied to the first encapsulation layer in locations corresponding to the periphery of the second encapsulation layer (and on the side or surface facing the second encapsulation layer), then the second encapsulation layer is placed on the first encapsulation layer and pressure is applied thereto.

Alternatively, in one or more embodiments, the second encapsulation layer may be applied to the first encapsulation layer by laminating the second encapsulation layer, the electrochromic display and the first encapsulation layer. In one or more further alternative embodiments, the second encapsulation layer may applied to the first encapsulation layer by printing the second encapsulation layer (or an ink or other liquid comprising the material[s] of the second encapsulation layer) on and/or over the electrochromic display and areas of the first encapsulation layer immediately adjacent to the electrochromic display. For example, the second encapsulation layer may be printed on the first encapsulation layer by screen printing, inkjet printing, extrusion coating (extrusion printing), slot die coating, gravure printing, or other printing process that can be adapted for sheet processing or roll-to-roll processing, as described herein.

In one or more embodiments, the method may be adapted for roll-to-roll processing. A high-volume, low-cost process for manufacturing encapsulated electrochromic displays can be achieved using roll-to-roll processing. In order to facilitate high-volume roll-to-roll (R2R) production, processing steps in the present method may be performed relatively quickly (e.g., compared to more conventional thin film and/or blanket deposition-and patterning processes). The processing steps in the present method (e.g., printing, conditioning, encapsulating, and optionally, post-processing (e.g., laminating, separating [e.g., singulating] and placing on another substrate or object, conversion, etc.) as described herein are easily adaptable to roll-to-roll processing. In one or more further embodiments, the present method may further comprise electrical and/or functional testing of the encapsulated electrochromic displays.

### CONCLUSION

Thus, the present invention provides a method for encapsulating an electrochromic display, comprising forming the electrochromic display on a first encapsulation layer, conditioning the electrochromic display in an environment having a relative humidity of from 20% to 55%, and applying a second encapsulation layer on the electrochromic display such that the first and second encapsulation layers encapsulate the electrochromic display. The electrochromic display comprises at least a first electrode, a second electrode, and an electrochromic layer between the first and second electrodes. At least one of the first and second encapsulation layers is optically transparent. The present invention also provides an encapsulated electrochromic display, comprising the first encapsulation layer, the electrochromic display, and the second encapsulation layer. The electrochromic layer contains water equilibrated to or in an atmosphere with a relative humidity of from 20% to 55%, and the first and second encapsulation layers encapsulate the electrochromic display so that the water or moisture content of the electrochromic layer and/or electrochromic display remains at an optimal level.

The present invention also provides a solution to problems with implementing processing steps in a high-volume manufacturing or production process using standard or conventional printing equipment under normal or typical processing conditions (e.g., using roll-to-roll printing equipment in a typical processing environment, at room temperature and a moderately controlled humidity).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for encapsulating an electrochromic display, comprising:
a) forming the electrochromic display on a first encapsulation layer, the electrochromic display comprising at least a first electrode, a second electrode, and an electrochromic layer between the first and second electrodes, at least one of the first and second electrodes being formed by a roll-to-roll printing process and comprising a material having an air or water vapor permeability sufficient to allow water vapor to permeate the electrochromic layer during the roll-to-roll printing process;
b) conditioning the electrochromic display in an environment having a predetermined minimum water vapor therein such that the electrochromic layer contains a predetermined minimum amount of water or moisture therein; and
c) applying a second encapsulation layer on the electrochromic display such that the first and second encapsulation layers encapsulate said electrochromic display, wherein at least one of the first and second encapsulation layers is optically transparent.

2. The method of claim 1, wherein conditioning the electrochromic display results in the electrochromic layer containing water in an amount equilibrated to an atmosphere with a relative humidity of from 20% to 55%.

3. The method of claim 2, wherein the environment has a temperature of from 15° C. to 30° C.

4. The method of claim 1, wherein each of the first and second encapsulation layers comprises a moisture barrier layer.

5. The method of claim 1, wherein applying the second encapsulation layer comprises adhering the second encapsulation layer to the first encapsulation layer using an adhesive.

6. The method of claim 1, wherein applying the second encapsulation layer comprises laminating the second encapsulation layer, the electrochromic display and the first encapsulation layer.

7. The method of claim 1, wherein applying the second encapsulation layer comprises printing the second encapsulation layer on the electrochromic display and the first encapsulation layer.

8. The method of claim 1, wherein the first encapsulation layer is optically transparent.

9. The method of claim 8, wherein the first electrode is optically transparent.

10. The method of claim 1, wherein the second electrode comprises the material having the air or water vapor permeability sufficient to allow water vapor to permeate the electrochromic layer during the roll-to-roll printing process.

11. The method of claim 10, wherein the second electrode comprises carbon.

12. The method of claim 11, wherein the carbon is graphite and/or carbon black.

13. The method of claim 11, wherein forming the electrochromic display comprises printing an ink comprising the carbon, a binder and a solvent to form the second electrode.

14. The method of claim 1, further comprising forming a first trace or lead electrically connected to the first electrode, and forming a second trace or lead electrically connected to the second electrode.

15. The method of claim 14, further comprising affixing or mounting the encapsulated electrochromic display to a substrate, and exposing ends of the first and second traces or leads through openings or windows in the substrate.

16. The method of claim 1, wherein forming the electrochromic display comprises printing a first ink on the first encapsulation layer to form the first electrode, printing a second ink on the first electrode to form the electrochromic layer, and printing a third ink on the electrochromic layer to form the second electrode.

17. An encapsulated electrochromic display, comprising:
a) a first encapsulation layer;
b) an electrochromic display comprising at least a first electrode, a second electrode, and an electrochromic layer between the first and second electrodes, at least one of the first and second electrodes comprising a material having an air or water vapor permeability sufficient to allow water vapor to permeate the electrochromic layer during a roll-to-roll printing process; and
c) a second encapsulation layer on the electrochromic display such that the first and second encapsulation layers encapsulate said electrochromic display,
wherein the electrochromic layer includes a predetermined minimum amount of water or moisture therein, and at least one of the first and second encapsulation layers is optically transparent.

18. The encapsulated electrochromic display of claim 17, wherein the predetermined minimum amount of water or moisture is an amount of water equilibrated to an atmosphere with a relative humidity of from 20% to 55% at a temperature of from 15° C. to 30° C.

19. The encapsulated electrochromic display of claim 17, wherein the first encapsulation layer is optically transparent, each of the first and second encapsulation layers have length and width dimensions greater than those of the first and second electrodes and the electrochromic layer, and the length and width dimensions of the first encapsulation layer are greater than those of the second encapsulation layer.

20. The encapsulated electrochromic display of claim 17, further comprising one or more first traces or leads electrically connected to the first electrode and one or more second traces or leads electrically connected to the second electrode, wherein the one or more second traces or leads are electrically isolated from the one or more first traces or leads, and at least a part of each of the first and second traces or leads is exposed by the second encapsulation layer.
